(19) United States
(12) Patent Application Publication
(10) Pub. No.: US 2025/0357796 A1
(43) Pub. Date: Nov. 20, 2025

(54) POWER TRANSMISSION APPARATUS, METHOD PERFORMED BY POWER TRANSMISSION APPARATUS, AND STORAGE MEDIUM

(71) Applicant: CANON KABUSHIKI KAISHA, Tokyo (JP)

(72) Inventors: TAKATOSHI HIROSE, Kanagawa (JP); TAKAHIRO SHICHINO, Tokyo (JP)

(21) Appl. No.: 19/287,620

(22) Filed: Jul. 31, 2025

Related U.S. Application Data
(63) Continuation of application No. PCT/JP2024/004500, filed on Feb. 9, 2024.

(30) Foreign Application Priority Data
Feb. 24, 2023 (JP) 2023-027472
Apr. 5, 2023 (JP) 2023-061307

(51) Int. Cl. H02J 50/40; H02J 50/12; H02J 50/80

(52) U.S. Cl. CPC H02J 50/402; H02J 50/12; H02J 50/80

(57) ABSTRACT

A power transmission apparatus 200 includes a first power transmitter 207a configured to wirelessly transmit power to a first power receiving apparatus 400a, and a second power transmitter 207b configured to wirelessly transmit power to a second power receiving apparatus 400b. In a case where the second power transmitter 207b receives a request for transmission of information regarding an electronic certificate from the second power receiving apparatus 400b before the first power transmitter 207a receives the request for transmission of information regarding the electronic certificate from the first power receiving apparatus 400a and the first power transmitter 207a transmits the information regarding the electronic certificate, the second power transmitter 207b transmits a signal (BUSY) different from the information regarding the electronic certificate.

### CROSS-REFERENCE TO RELATED APPLICATIONS

This application is a Continuation of International Patent Application No. PCT/JP2024/004500, filed Feb. 9, 2024, which claims the benefit of Japanese Patent Applications No. 2023-027472, filed Feb. 24, 2023, and No. 2023-061307, filed Apr. 5, 2023, all of which are hereby incorporated by reference herein in their entirety.

### BACKGROUND OF THE INVENTION

### Field of the Invention

The present disclosure relates to a technique of wireless power transmission.

### Background Art

In recent years, the technical development of a wireless power transmission system has been widely performed. PTL 1 discusses performing wireless power transmission to a power receiving apparatus using a power transmission apparatus including a plurality of power transmitters.

### CITATION LIST

### Patent Literature

PTL 1: Japanese Patent Application Laid-Open No. 2015-39271

Nevertheless, PTL 1 does not discuss an appropriate control method of a plurality of power receiving apparatuses or a plurality of power receivers in a power transmission apparatus including a plurality of power transmitters, and there is a possibility that appropriate control cannot be performed in processing related to authentication with a plurality of power receiving apparatuses, for example.

### SUMMARY OF THE INVENTION

According to an aspect of the present disclosure, a power transmission apparatus includes a first transmission unit configured to wirelessly transmit power to a power receiving apparatus, and a second transmission unit configured to wirelessly transmit power to a power receiving apparatus. In a case where the second transmission unit receives a request for transmission of information regarding an electronic certificate from a power receiving apparatus before the first transmission unit receives a request for transmission of information regarding an electronic certificate from a power receiving apparatus and the first transmission unit transmits the information regarding the electronic certificate, the second transmission unit transmits a signal different from the information regarding the electronic certificate.

According to an exemplary embodiment of the present disclosure, it is possible to provide a technique of performing appropriate authentication between a plurality of power receiving apparatuses for a power transmission apparatus including a plurality of power transmitters.

Further features of the present invention will become apparent from the following description of exemplary embodiments with reference to the attached drawings.

### BRIEF DESCRIPTION OF THE DRAWINGS

FIG. 1A is a diagram illustrating a system configuration.

FIG. 1B is a diagram illustrating a system configuration.

FIG. 2A is a diagram illustrating a configuration example of a power transmission apparatus.

FIG. 2B is a diagram illustrating a configuration example of a power transmission apparatus.

FIG. 3A is a diagram illustrating a configuration example of a power receiving apparatus.

FIG. 3B is a diagram illustrating a configuration example of a power receiving apparatus.

FIG. 3C is a diagram illustrating a configuration example of a power receiving apparatus.

FIG. 4A is a diagram illustrating an identification information example of a power transmission apparatus and a power receiving apparatus.

FIG. 4B is a diagram illustrating an identification information example of a power transmission apparatus and a power receiving apparatus.

FIG. 5 is a diagram illustrating a capability information example of a power transmission apparatus and a power receiving apparatus.

FIG. 6A is a sequence diagram illustrating an operation of a power transmission apparatus and a power receiving apparatus.

FIG. 6B is a sequence diagram illustrating an operation of a power transmission apparatus and a power receiving apparatus.

FIG. 6C is a sequence diagram illustrating an operation of a power transmission apparatus and a power receiving apparatus.

FIG. 6D is a sequence diagram illustrating an operation of a power transmission apparatus and a power receiving apparatus.

FIG. 6E is a sequence diagram illustrating an operation of a power transmission apparatus and a power receiving apparatus.

FIG. 7A is a flowchart illustrating an operation of a power receiving apparatus according to first and second exemplary embodiments.

FIG. 7B is a flowchart illustrating an operation of a power receiving apparatus according to the first and second exemplary embodiments.

FIG. 7C is a flowchart illustrating an operation of a power receiving apparatus according to the first and second exemplary embodiments.

FIG. 7D is a flowchart illustrating an operation of a power receiving apparatus according to the first and second exemplary embodiments.

FIG. 8A is a flowchart illustrating an operation of a power transmission apparatus according to third and fourth exemplary embodiments.

FIG. 8B is a flowchart illustrating an operation of a power transmission apparatus according to the third and fourth exemplary embodiments.

FIG. 9 is a flowchart illustrating an operation of a power transmission apparatus according to a modified example of the fourth exemplary embodiment.

FIG. 10 is a flowchart illustrating an operation of a power receiving apparatus according to a modified example of the fourth exemplary embodiment.

FIG. 11A is a sequence diagram illustrating operations of a power transmission apparatus and a power receiving apparatus according to a modified example of the fourth exemplary embodiment.

FIG. 11B is a sequence diagram illustrating operations of a power transmission apparatus and a power receiving apparatus according to a modified example of the fourth exemplary embodiment.

FIG. 11C is a sequence diagram illustrating operations of a power transmission apparatus and a power receiving apparatus according to a modified example of the fourth exemplary embodiment.

FIG. 11D is a sequence diagram illustrating operations of a power transmission apparatus and a power receiving apparatus according to a modified example of the fourth exemplary embodiment.

### DESCRIPTION OF THE EMBODIMENTS

Hereinafter, exemplary embodiments of the present disclosure will be described in detail with reference to the accompanying drawings. In the exemplary embodiments, a wireless charging system will be described to which a wireless power transmission system is applied. As an example, wireless power transmission that is based on a standard (hereinafter, will be referred to as a “WPC standard”) stipulated by the Wireless Power Consortium (WPC), which is a standard-setting organization, will be described. The following exemplary embodiment merely indicates an example for describing a technical idea of the present disclosure, and is not intended to limit the present disclosure to the configuration and the method to be described in the exemplary embodiment. A plurality of features is described in the exemplary embodiment, but not all the plurality of features is essential to the present disclosure. The plurality of features may also be arbitrarily combined. In the accompanying drawings, the same or similar components are also assigned the same reference numerals.

### First Exemplary Embodiment

### System Configuration

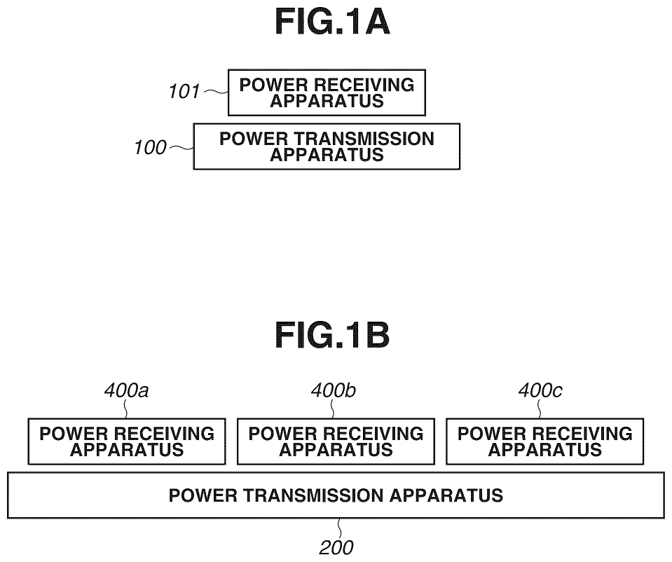

A configuration of a system according to an exemplary embodiment will be described with reference to FIG. 1A. FIG. 1A is a diagram illustrating a configuration example of a wireless power transmission system. The wireless power transmission system includes a power transmission apparatus 100 and a power receiving apparatus 101. The power transmission apparatus 100 is an electronic device that wirelessly transmits power via a power transmission antenna to the power receiving apparatus 101 placed on the power transmission apparatus 100, for example. The power receiving apparatus 101 is an electronic device that charges a built-in battery by receiving power from the power transmission apparatus 100, for example. The exemplary embodiments include an exemplary embodiment in which the power transmission apparatus 100 and the power receiving apparatus 101 are separate apparatuses, and an exemplary embodiment in which these apparatuses are included in a different apparatus. The different apparatus includes an imaging apparatus, a smartphone, a tablet personal computer (PC), a laptop PC, an automobile, a robot, a medical device, or a printer, and can supply power to various apparatuses.

### Power Transmission Apparatus

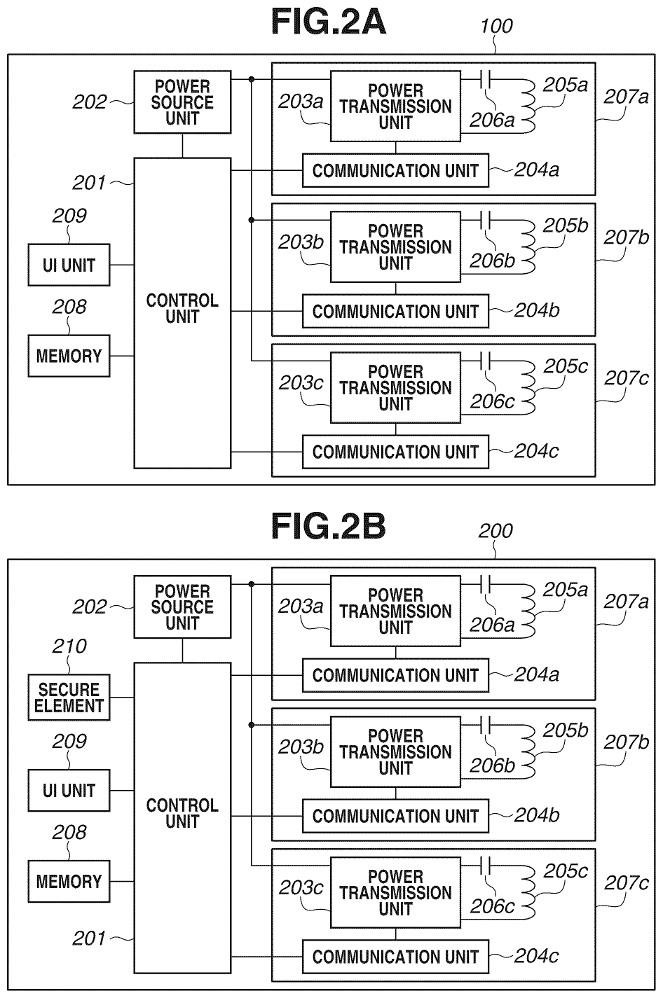

A configuration example of the power transmission apparatus 100 will be described with reference to FIG. 2A. FIG. 2A is a functional block diagram illustrating a configuration example of the power transmission apparatus 100. The power transmission apparatus 100 includes a control unit 201, a power source unit 202, a plurality of power transmission units 203, a plurality of communication units 204, a plurality of power transmission antennas (power transmission coils) 205, a plurality of resonance capacitors 206, a memory 208, and a user interface (hereinafter, will be described as UI) unit 209. In FIG. 2A, functional block elements are illustrated as separate functional block elements, but a plurality of arbitrary functional block elements can be mounted within a same chip.

The power transmission apparatus 100 can include a plurality of control units 201, a plurality of power source units 202, or a plurality of memories 208.

The power transmission apparatus 100 includes N power transmission units 203, N communication units 204, N power transmission antennas 105, and N resonance capacitors 206. In the present exemplary embodiment, N will be described as three to simplify the explanation, but N is not limited to this. N is only required to be an integer equal to or larger than two. In the present exemplary embodiment, an example in which N is three will be described. Specifically, an example will be described. in which the power transmission apparatus 100 includes three power transmission units 203a, 203b, and 203c, and three communication units 204a, 204b, and 204c. The communication units 204a, 204b, and 204c are respectively connected to the corresponding power transmission units 203a, 203b, and 203c. The power transmission apparatus 100 also includes three power transmission antenna 105a, 105b, and 105c, and N resonance capacitors 206a, 206b, and 206c. In the power transmission apparatus 100, a power transmission unit, a power transmission antenna, and a resonance capacitor that have the same alphabet added to reference numerals form a set. For example, the power transmission unit 203a, the power transmission antenna 205a, and the resonance capacitor 206a form a set. The power transmission antenna 205a and the resonance capacitor 206a are connected in series. In the present exemplary embodiment, it is assumed that the N power transmission units 203, the N communication units 204, the N power transmission antennas 205 and the N resonance capacitors 206 all have the same characteristics, but these can have different characteristics.

It is also assumed that a unit including the power transmission unit 203a, the communication unit 204a, the power transmission antenna 205a, and the resonance capacitor 206a is a first power transmitter 207a. It is also assumed that a unit including the power transmission unit 203b, the communication unit 204b, the power transmission antenna 205b, and the resonance capacitor 206b is a second power transmitter 207b. It is also assumed that a unit including the power transmission unit 203c, the communication unit 204c, the power transmission antenna 205c, and the resonance capacitor 206c is a third power transmitter 207c. That is, the power transmission apparatus 100 includes three power transmitters. Hereinafter, in a case where no distinction is made, the description will be given while omitting a, b, and c of reference numerals.

The control unit 201 controls the entire power transmission apparatus 100 including the first power transmitter 207a, the second power transmitter 207b, and the third power transmitter 207c by executing a control program stored in the memory 208. The control unit 201 can also perform power transmission control including communication for device authentication in the power transmission apparatus 100. The control unit 201 can also perform control for executing an application other than wireless power transmission. The control unit 201 includes one or more processors such as a central processing unit (CPU) or a microprocessor unit (MPU). Alternatively, the control unit 201 can also include hardware such as an application specific integrated circuit (ASIC). The control unit 201 can also include an array circuit such as a field programmable gate array (FPGA) complied to execute predetermined processing. The control unit 201 can execute processing of storing information to be stored during the execution of various types of processing into the memory 208, and time measurement processing that uses a timer (not illustrated).

The power source unit 202 is a power source that supplies power to be used when at least the control unit 201 and each power transmission unit 203 operate. The power source unit 202 can be a wired power receiving circuit or a battery that receives power supply from a commercial power source, for example. Power supplied from a commercial power source is accumulated in the battery.

The power transmission unit 203 converts direct-current power or alternating-current power input from the power source unit 202, into alternating-current power in a frequency band to be used for wireless power transmission, and inputs the alternating-current power to the power transmission antenna 205, thereby generating electromagnetic waves for causing the power receiving apparatus 101 to receive power. For example, the power transmission unit 203 includes an inverter, and converts a direct-current voltage supplied by the power source unit 202 into an alternating-current voltage with a switching circuit having a half-bridge or full-bridge configuration. The power transmission unit 203 includes a plurality of field effect transistors (FETs) constituting a bridge, and a gate driver that controls ON/OFF of the plurality of FETs.

The power transmission unit 203 adjusts either or both of a voltage (power transmission voltage) and a current (power transmission current) to be input to the power transmission antenna 205, thereby controlling the strength of electromagnetic waves (transmitted power) to be output. The strength of electromagnetic waves (equivalent to the magnitude of transmitted power, hereinafter, also referred to as strength) is controlled by the magnitude of the power transmission voltage or the power transmission current. For example, in a case where the power transmission unit 203 includes an inverter, the strength of electromagnetic waves to be output is controlled by adjusting either or both of a voltage and a current to be input to the inverter. Alternatively, the strength of electromagnetic waves to be output is controlled by adjusting either or both of a voltage and a current to be output from an inverter included in the power transmission unit 203. By issuing an instruction to the power transmission unit 203, the control unit 201 performs power transmission start and stop control, and also controls the strength of electromagnetic waves to be output. The power transmission unit 203 performs, based on an instruction signal from the control unit 201, output control of power of electromagnetic waves in an alternating-current frequency such that start or stop of power transmission by the power transmission antenna 205 or the strength of electromagnetic waves to be output is controlled. It is also assumed that the power transmission unit 203 has power supply capability of outputting 15-watt (W) power to a charging unit of the power receiving apparatus 101 supporting a WPC standard. That is, the potential load power of the power transmission unit 203 is 15 W.

The communication unit 204 is connected with the control unit 201 and the power transmission unit 203, and performs communication for power transmission control based on the WPC standard, with the power receiving apparatus 101. The communication unit 204 performs communication by performing frequency shift modulation of electromagnetic waves to be output from the power transmission antenna 205, and transmitting information to the power receiving apparatus 101. The communication unit 204 also acquires information transmitted by the power receiving apparatus 101, by demodulating electromagnetic waves transmitted from the power transmission antenna 205 that have been modulated by the power receiving apparatus 101. The communication by the communication unit 204 is performed by a communication signal being superimposed on electromagnetic waves transmitted from the power transmission antenna 205.

Aside from control programs, the memory 208 can store information regarding states of the power transmission apparatus 100 and the power receiving apparatus 101. The information regarding states of the power transmission apparatus 100 and the power receiving apparatus 101 includes a transmitted power value and a received power value. Information regarding the state of the power transmission apparatus 100 is acquired by the control unit 201. Information regarding the state of the power receiving apparatus 101 is acquired by a control unit of an RX, and can be received by the communication unit 204.

The UI unit 209 is connected with the control unit 201, and performs various types of output to users. The various types of output include operations such as screen display, blinking or color change of a light emitting diode (LED), voice output by a speaker, and vibration of a TX main body. The UI unit 209 is implemented by a liquid crystal panel, a speaker, or a vibration motor.

### Power Receiving Apparatus

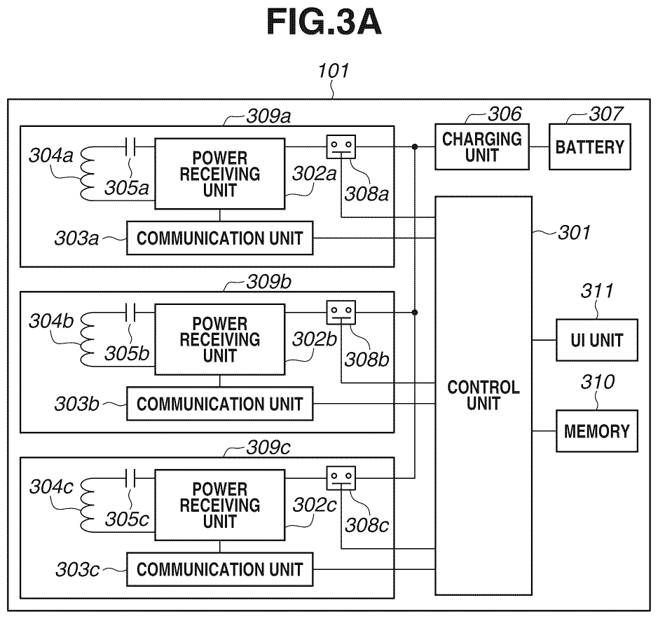

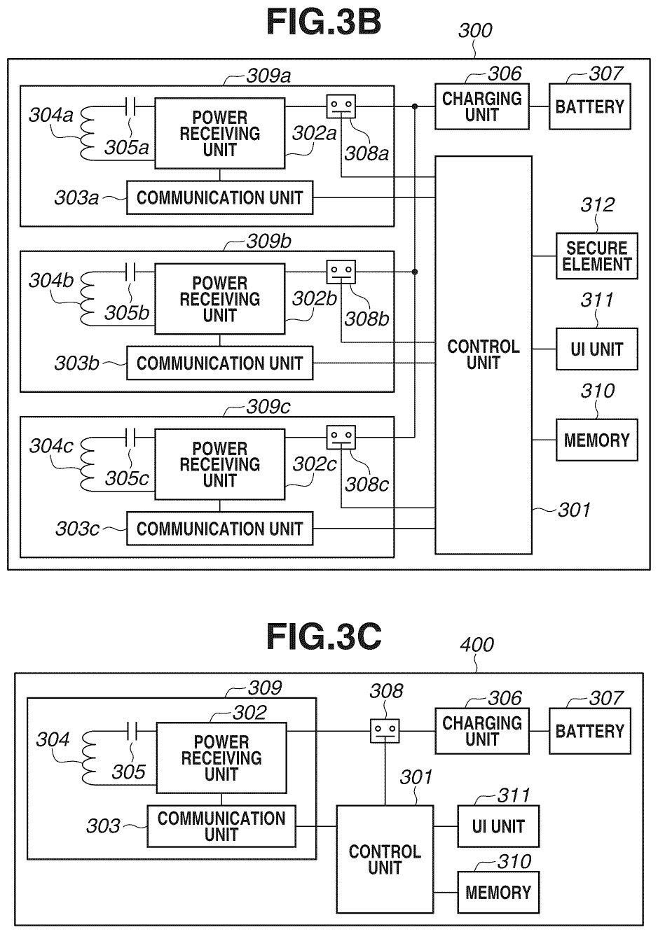

Next, a configuration example of the power receiving apparatus 101 will be described with reference to FIG. 3A. FIG. 3A is a block diagram illustrating a configuration example of the power receiving apparatus 101. The power receiving apparatus 101 includes a control unit 301, a plurality of power receiving units 302, a plurality of communication units 303, a plurality of power receiving antennas 304, a plurality of resonance capacitors 305, a charging unit 306, a battery 307, a plurality of switch units 308, a memory 310, and a UI unit 311. The power receiving apparatus 101 can also include a plurality of control units 301, a plurality of charging units 306, a plurality of batteries 307, or a plurality of memories 310.

In the present exemplary embodiment, the power receiving apparatus 101 includes N power receiving units 302, N communication units 303, N power receiving antennas 304, N resonance capacitors 305, and N switch units 308.

In the present exemplary embodiment, N will be described as three to simplify the explanation, but N is not limited to this. N is only required to be an integer equal to or larger than two. In the present exemplary embodiment, an example in which Nis three will be described. Specifically, an example will be described in which the power receiving apparatus 101 includes three power receiving units 302a, 302b, and 302c, and three communication unit 303a, 303b, and 303c. The communication units 303a, 303b, and 303c are respectively connected to the corresponding power receiving units 302a, 302b, and 302c.

The power receiving apparatus 101 also includes three power receiving antennas 304a, 304b, and 304c, three resonance capacitors 305a, 305b, and 305c, and three switch units 308a, 308b, and 308c. In the power receiving apparatus 101, a power receiving unit, a power receiving antenna, a resonance capacitor, a communication unit, and a switch unit that have the same alphabet added to reference numerals form a set. For example, the power receiving unit 302a, the power receiving antenna 304a, the resonance capacitor 305a, the communication unit 303a, and the switch unit 308a form a set. The power receiving antenna 304a and the resonance capacitor 305a are connected in series. In the present exemplary embodiment, it is assumed that all of N power receiving units 302, N communication units 303, N power receiving antennas 304, and N resonance capacitors 305 have the same characteristics, but these can have different characteristics.

It is assumed that a unit including the power receiving unit 302a, the communication unit 303a, the power receiving antenna 304a, the resonance capacitor 305a, and the switch unit 308a is a first power receiver 309a. It is also assumed that a unit including the power receiving unit 302b, the communication unit 303b, the power receiving antenna 304b, the resonance capacitor 305b, and the switch unit 308b is a second power receiver 309b. It is also assumed that a unit including the power receiving unit 302c, the communication unit 303c, the power receiving antenna 304c, the resonance capacitor 305c, and the switch unit 308c is a third power receiver 309c. That is, the power receiving apparatus 101 includes three power receivers. Hereinafter, in a case where no distinction is made, the description will be given while omitting reference numerals of a, b, and c.

The control unit 301 controls functional block elements of the power receiving apparatus 101, which includes the first power receiver 309a, the second power receiver 309b, and the third power receiver 309c, by executing a control program stored in the memory 310. The control unit 301 can also perform control for executing an application other than wireless power transmission. The control unit 301 includes one or more processors such as a CPU or an MPU. The control unit 301 can also control the entire RX (e.g., the entire smartphone) by cooperation with an operating system (OS) executed by the control unit 301. Alternatively, the control unit 301 includes hardware such as an ASIC, or includes an array circuit such as an FPGA complied to execute predetermined processing. The control unit 301 stores information to be stored during the execution of various types of processing, into the memory 310, and can execute time measurement processing that uses a timer (not illustrated).

The UI unit 311 is connected with the control unit 301, and performs various types of output to users. The various types of output include operations such as screen display, blinking or color change of a light emitting diode (LED), voice output with a speaker, and vibration of an RX main body. The UI unit 311 is implemented with a liquid crystal panel, a speaker, or a vibration motor.

The power receiving unit 302 receives, via the power receiving antenna (power receiving coil) 304, alternating-current power (alternating-current voltage and alternating-current) generated by electromagnetic induction that is based on electromagnetic waves emitted from the power transmission antenna 205 of the power transmission apparatus 100. The power receiving unit 302 then converts alternating-current power into direct-current power or alternating-current power of a predetermined frequency, and outputs power to the charging unit 306. The charging unit 306 charges the battery 307. The power receiving unit 302 includes a rectifying unit (rectifier, rectifying circuit) and a voltage control unit that are necessary for power supply to load in the power receiving apparatus 101. The rectifying unit converts an alternating-current voltage and an alternating-current from the power transmission antenna 205 that have been received via the power receiving antenna 304, into a direct-current voltage and a direct-current. The voltage control unit also converts a level of a direct-current voltage input from the rectifying unit, into a predetermined level. The predetermined level is a level of a direct-current voltage at which operations of the control unit 301 and the charging unit 306 can be performed. The power receiving unit 302 supplies power for charging the battery 307 via the charging unit 306. The power receiving unit 302 has power supply capability of outputting 15-W (watts) power to the charging unit 306.

The communication unit 303 performs communication for power receiving control that is based on the WPC standard, with the communication unit 204 included in the power transmission apparatus 100. The communication unit 303 is connected with the power receiving antenna 304 and the control unit 301. The communication unit 303 acquires information transmitted from the power transmission apparatus 100, by demodulating electromagnetic waves input from the power receiving antenna 304. The communication unit 303 performs load modulation or amplitude modulation on input electromagnetic waves, and superimposes a signal related to information to be transmitted to the power transmission apparatus 100, on the electromagnetic waves, thereby communicating with the power transmission apparatus 100.

Aside from control programs, the memory 310 can store information regarding states of the power transmission apparatus 100 and the power receiving apparatus 101. Information regarding the state of the power receiving apparatus 101 is acquired by the control unit 301. In addition, information regarding the state of the power transmission apparatus 100 is acquired by the control unit 201 of the power transmission apparatus 100, and can be received by the communication unit 303.

The switch unit 308 is provided between the power receiving unit 302a and the charging unit 306, and is controlled by the control unit 301. The switch unit 308 has a function of controlling whether to supply power received by the power receiving unit 302, to the charging unit 306 and the battery 307. In a case where the switch unit 308 is brought into an OFF state and opened by the control unit 301, power received by the power receiving unit 302 is not supplied to the charging unit 306 and the battery 307. In a case where the switch unit 308 is brought into an ON state and short-circuited by the control unit 301, power received by the power receiving unit 302 is supplied to the charging unit 306 and the battery 307.

In the example illustrated in FIG. 3A, the switch units 308 are respectively arranged between the power receiving unit 302a, the power receiving unit 302b, and the power receiving unit 302c, and the charging unit 306, but can be arranged at other locations. In the example illustrated in FIG. 3A, the switch unit 308 is illustrated as one functional block element, but the switch unit 308 can be implemented as a part of the charging unit 306 or the power receiving unit 302. In addition, a configuration is not limited to a configuration in which the switch unit 308 is inserted in series between the power receiving unit 302 and the charging unit 306, and the switch unit 308 can be inserted in parallel between the power receiving unit 302 and the charging unit 306. In such a case, when the switch unit 308 is brought into the OFF state and opened by the control unit 301, power received by the power receiving unit 302 is supplied to the charging unit 306 and the battery 307. In a case where the switch unit 308 is brought into the ON state and short-circuited by the control unit 301, power received by the power receiving unit 302 is not supplied to the charging unit 306 and the battery 307.

### WPC Standard Sequence

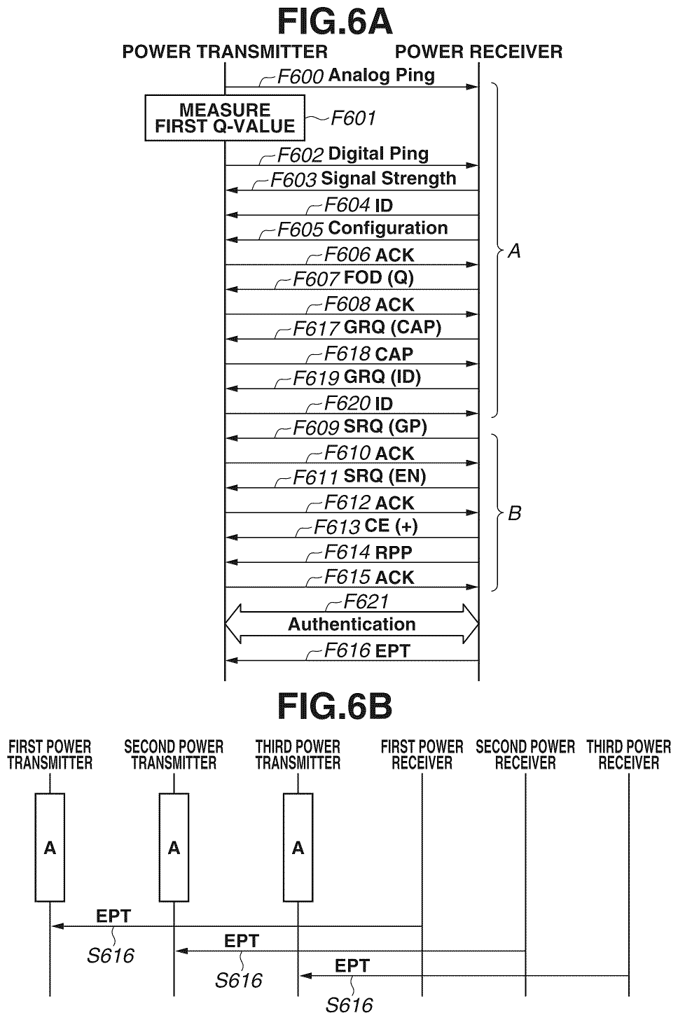

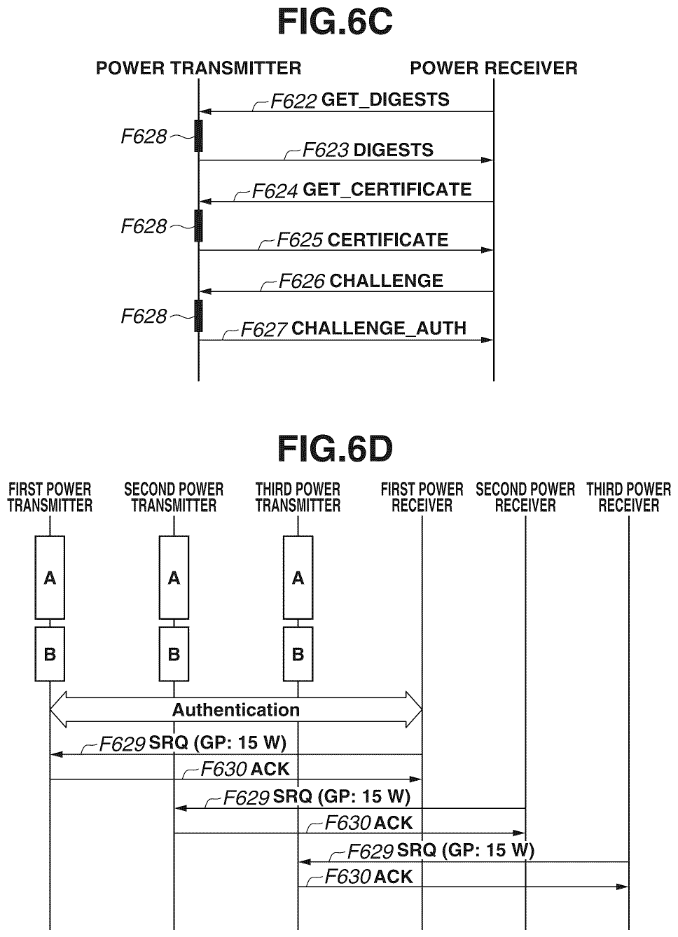

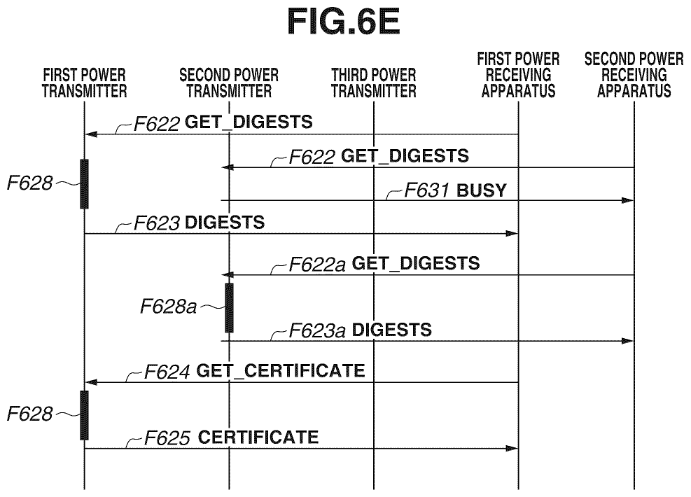

FIG. 6A is a sequence diagram illustrating a flow of control of a power transmitter and a power receiver that complies with a WPC standard. Authentication in F621 may be performed, or may be omitted. For this reason, the description here will be omitted, and the description will be given in a second and subsequent exemplary embodiments. The power transmitter transmits Analog Ping (hereinafter, will be represented as A-Ping) to detect an object existing near a power transmission coil (F600). The A-Ping is pulsed power, and is power for detecting an object. The A-Ping also has such small power that, even when the power receiver receives the A-Ping, the power receiver cannot be activated. The power transmitter detects an object based on a shift in a resonance frequency of a voltage value in the power transmission coil that is attributed to an object existing near the power transmission coil, or a change in a value of a voltage or a current flowing in the power transmission coil 205.

When the power transmitter detects an object using the A-Ping, the power transmitter measures a Q-value (quality factor, Q-factor) of the power transmission coil (F601). When Q-value measurement ends, the power transmitter starts the transmission of Digital Ping (hereinafter, will be represented as D-Ping) (F602). The D-Ping is power for activating the power receiver, and is power larger than the A-Ping. Subsequently, the D-Ping is continuously transmitted. In other words, the power transmitter continues to transmit power equal to or larger than the D-Ping from when the transmission of the D-Ping is started (F602), to when End Power Transfer (EPT) data requesting power transmission stop is received from the power receiver (F616).

When the power receiver is activated upon receiving the D-Ping, the power receiver transmits Signal Strength, which is data storing a voltage value of the received D-Ping, to the power transmitter (F603). The power receiver subsequently transmits data storing version information of the WPC standard with which the power receiving apparatus complies, and an ID including device identification information (F604). The power receiver also transmits Configuration data including information including a largest value of power to be supplied by the power receiving unit 302 to a load (or the charging unit 306), to the power transmitter (F605). When the power transmitter determines that the power receiver supports an expanded protocol equal to or later than the WPC standard v1.2 (including Negotiation to be described below), by receiving the ID and the Configuration data, the power transmitter makes a response with acknowledge (ACK) (F606).

When the power receiver receives the ACK, a phase transitions to a negotiation phase in which negotiation of power to be transmitted and received is performed. First of all, the power receiver transmits FOD Status data to the power transmitter (F607). In the present exemplary embodiment, the FOD Status data will be represented as FOD (Q). The power transmitter performs foreign object detection based on a Q-value stored in the received FOD (Q), and the Q-value measured in F602, and transmits ACK indicating that the power transmitter has determined that there is high possibility that no foreign object exists, to the power receiver (F608).

When the power receiver receives the ACK, the power receiver transmits a packet for inquiring about the capability of the power transmitter (F617). Specifically, the packet is a packet of General Request (Capability) (represented as GRQ (CAP)), which is one of General Requests defined in the WPC standard. When the power transmitter receives the GRQ (CAP), the power transmitter transmits Capability data (referred to as CAP) storing capability information indicating the capability of the power transmitter (F618).

Next, the power receiver transmits a packet requesting the transmission of identification information, to the power transmitter (F619). Specifically, the packet is a packet of General Request (ID) (represented as GRQ (ID)), which is one of General Requests defined in the WPC standard. When the power transmitter receives the GRQ (ID), the power transmitter transmits identification data (referred to as ID) storing identification information of the power transmitter (F620). The ID includes a supported standard version.

Subsequently, the power receiver performs negotiation of Guaranteed Load Power (represented as GP), which is a largest value of a value of power requested to be received. Specifically, the Guaranteed Load Power is power agreed in negotiation with the power transmitter. For example, the negotiation is performed by transmitting Specific Request data defined in the WPC standard, to the power transmitter (F609). Specifically, the Specific Request data stores a value of Requested Load Power requested by the power receiver. In the present exemplary embodiment, the data will be represented as SRQ (GP). The power transmitter responds to the SRQ (GP) in consideration of power transmission capability of the power transmitter. In a case where the power transmitter makes a response indicating that power requested by the power receiver is acceptable, the power transmitter transmits ACK (F610). In the present exemplary embodiment, the power receiving apparatus requests 5 W as Requested Load Power in the SRQ (GP).

When the negotiation of a plurality of parameters including GP ends, the power receiver transmits SRQ (EN) requesting negotiation end (End Negotiation) among Specific Requests, to the power transmitter (F611). The power transmitter transmits ACK to the SRQ (EN) (F612), and Negotiation ends. Subsequently, the phase transitions to a Calibration phase and a Power Transfer phase.

In the Power Transfer phase, the power receiver transmits Control Error (hereinafter, represented as CE) requesting the power transmitter to increase or decrease a power receiving voltage (or power receiving current, received power), to the power transmitter. The CE stores a sign and a numeral value. When the sign of the numeral value stored in the CE is a positive sign, the CE means that a power receiving voltage is to be increased. When the sign of the numeral value stored in the CE is a negative sign, the CE means that a power receiving voltage is to be decreased. When the numeral value is zero, the CE means that a power receiving voltage is to be maintained. Here, the power receiver transmits CE (+) indicating that a power receiving voltage is to be increased, to the power transmitter (F613).

When the power transmitter receives the CE (+), the power transmitter changes a setting value of a power transmission circuit, and increases a power transmission voltage. When received power increases in response to the CE (+), the power receiver supplies received power to the charging unit 306 serving as a load, and transmits a Received Power Packet (hereinafter, will be referred to as RPP) to the power transmitter (F614). Here, the RPP stores a received power value in a state in which the power receiver supplies the output of the power receiving unit 302 to the load (the charging unit 306).

When the power transmitter receives the RPP, the power transmitter performs foreign object detection. In a case where a difference between a transmitted power value and a received power value that are set when the RPP is received is larger than or equal to a threshold value, the power transmitter determines that there is a possibility that a foreign object exists.

The foreign object described in the present disclosure refers to an object that does not constitute a part of a power receiver and a product into which the power receiver is incorporated, or does not constitute a part of a power transmitter and a product into which the power transmitter is incorporated, and has a possibility of producing heat when being exposed to a power signal. The foreign object is, for example, a clip or an integrated circuit (IC) card. The foreign object does not include an object having a possibility of involuntarily producing heat when being exposed to wireless power transmitted by a power transmission antenna, among objects in parts necessary for a power receiver and a product into which the power receiver is incorporated, or a power transmitter and a product into which the power transmitter is incorporated.

In a case where the power transmitter determines that there is high possibility that no foreign object exists, as a result of foreign object detection, the power transmitter transmits ACK to the power receiver (F615). Here, in a case where the power transmitter determines that there is high possibility that a foreign object exists, the power transmitter transmits negative acknowledgement (NAK) to the power receiver.

When the charging of the battery 307 ends, the power receiver transmits End Power Transfer (EPT) data requesting a stop of power transmission, to the power transmitter (F616). The above-described flow is a flow of control of the power transmitter and the power receiver that complies with the WPC standard.

### Exemplary Embodiment Flowchart

In the present exemplary embodiment, processing to be performed by the power receiving apparatus 101 illustrated in FIG. 3A will be described. Then, an example in which the power receivers 309a, 309b, and 309c receive identification information from power transmitters of the power transmission apparatus 100. The power receiving apparatus 101 as illustrated in FIG. 3A has the following issues. For example, it is considered to perform power transmission to the three power receivers 309 of the power receiving apparatus 101 from three power transmission apparatuses (not illustrated) each including one power transmitter. In this case, the three power transmission apparatuses are separate bodies, and each can independently change its position. In contrast, the three power receivers 309 are arranged in one power receiving apparatus 101, and relative positional relationships are fixed. For this reason, when a positional shift between each power transmitter of each power transmission apparatus and the power receiver 309 occurs due to the influence of vibration, it is considered that appropriate power transmission and receiving fail to be performed. That is, there is a possibility that power becomes unstable due to a positional shift during charging. The present exemplary embodiment is directed to provide a stable power transmission technique.

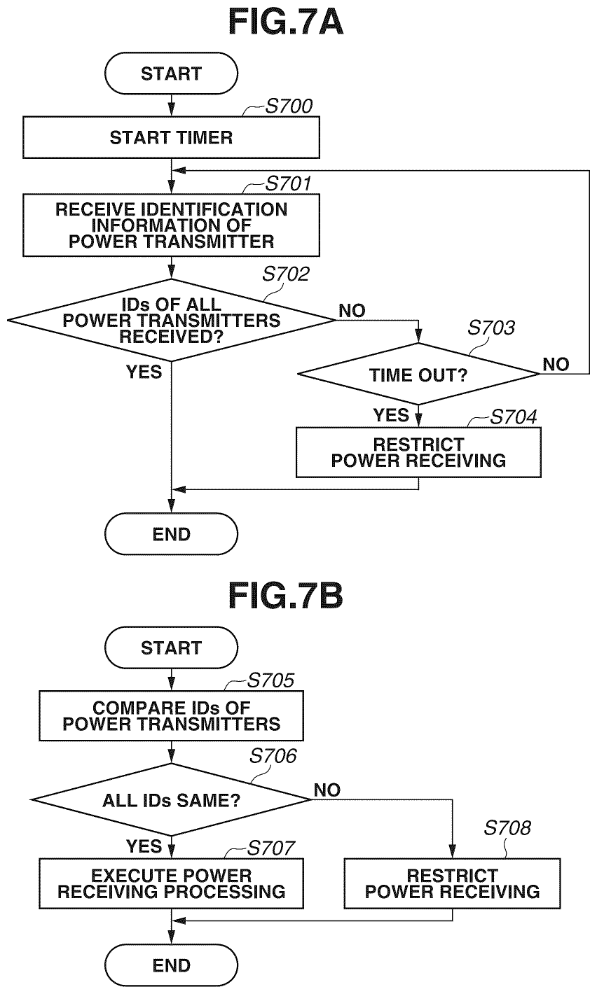

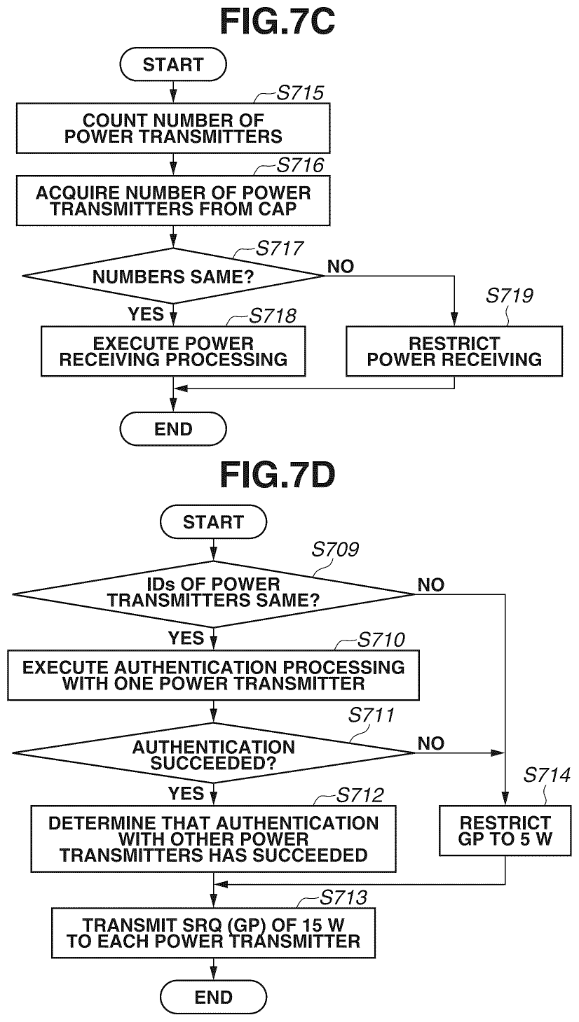

First of all, a flowchart of the power receiver 309 in FIG. 7A will be described. The power receiver 309 and a power transmitter execute the processing illustrated in FIG. 6A. FIG. 7A illustrates processing of collecting an identification code of a power transmitter, and corresponds to F619 to F620. At the beginning of collection processing, in step S700, a timer in the control unit 301 is activated. After the timer is activated, the power receiver 309 transmits the packet in F619 to collect identification information of a corresponding power transmitter. Here, the power receiver 309 inquires about an individual identification number of the power transmitter in F619. The power transmitter that has received the packet transmits individual identification information to the power receiver 309 serving as a communication partner. Here, the power transmitter transmits individual-identifiable information in F620. In step S701, the power receiver 309 receives individual identification information, and stores the received individual identification information into the memory 310, accordingly.

In step S702, it is determined whether individual identification information (ID) of each power transmitter corresponding to each power receiver 309 has been collected. In a case where the ID has not been collected (NO in step S702), the processing proceeds to step S703. In step S703, it is determined whether time-out has occurred by comparing a time measured by the timer and a time-out time. In a case where time-out has not occurred (NO in step S703), the processing returns to step S701, and the processing in step S701 is executed again. In a case where time-out has occurred (YES in step S703), the processing proceeds to step S704. In step S704, power receiving is restricted. For example, the restriction of power receiving is performed such that power is not to be received. That is to say, the restriction of power receiving can be performed by using EPT. Alternatively, the restriction of power receiving can be performed such that low power is to be received. That is to say, requested power stored in SRQ (GP) can be restricted to a value up to 5 W, for example. When the collection of individual identification information of each power transmitter corresponding to each power receiver 309 has been completed (YES in step S702), the processing proceeds to next processing.

FIG. 7B is a diagram illustrating a processing flow of the power receiving apparatus 101 in the case of YES in step S702. In step S705, the control unit 301 of the power receiving apparatus 101 compares collected individual identification information. In step S706, the control unit 301 then determines whether all pieces of individual identification information are the same. In a case where all pieces of individual identification information are the same (YES in step S706), the control unit 301 determines that all the power transmitters are included in one power transmission apparatus, and the processing proceeds to normal power receiving processing (step S707). For example, such a power transmission apparatus is the power transmission apparatus 100 illustrated in FIG. 2A, and the power transmitters 207 correspond to the respective power receivers 309.

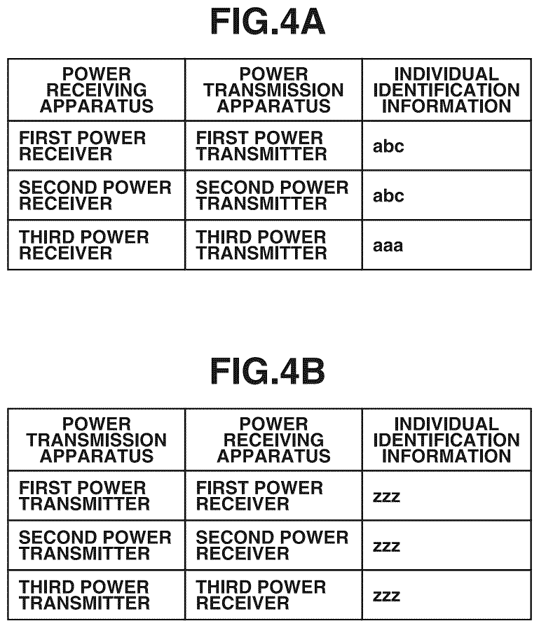

In contrast, in a case where collected results are not the same as illustrated in FIG. 4A (NO in step S706), the processing proceeds to step S708. In step S708, power receiving is restricted. The restriction of power receiving can be the same processing as the processing in step S704. The control unit 301 of the power receiving apparatus 101 that has determined that power is not to be received controls each power receiver 309 to transmit EPT to a corresponding power transmitter as illustrated in FIG. 6B (F616). In FIG. 6B, “A” indicates processing indicated by “A” in FIG. 6A.

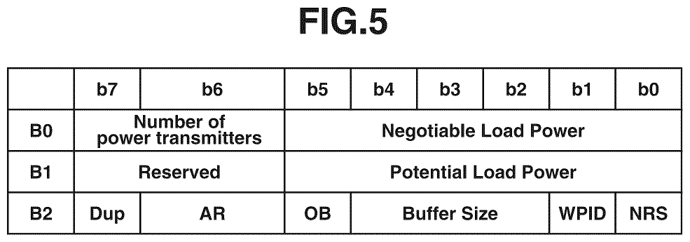

In the description of FIG. 6B, the power receiving apparatus 101 executes or restricts power receiving processing based on a determination criterion as to whether all IDs of power transmitters are the same. Nevertheless, this is executable even based on another determination criterion. Here, an example in which CAP, which is data storing capability information of a power transmitter, is used as a determination criterion will be described. FIG. 5 illustrates a frame format of CAP. In the present exemplary embodiment, a “Number of power transmitters” field in which the number of power transmitters included in the power transmission apparatus 100 is stored is provided by using Bit7 and Bit6 of Bank0 (B0) serving as reserved regions (reserved bits). Specifically, the power transmission apparatus 100 includes three power transmitters, and thus “11” indicating three as a binary number is stored in the field.

A processing flow of the power receiving apparatus 101 that uses information on CAP in FIG. 5 will now be described with reference to FIG. 7C. The power receiver 309 and a power transmitter execute the processing illustrated in FIG. 6A. In step S715, the power receiving apparatus 101 counts the number of power transmitters corresponding to the power receiver 309. For example, in a case where the power receivers 309 respectively correspond to the power transmitters 207 of the power transmission apparatus 100 illustrated in FIG. 2A, the number of power transmitters is “3”. Next, the power receiving apparatus 101 receives CAP illustrated in FIG. 5, from the power transmission apparatus 100 in F618. In step S716, a value in the “Number of power transmitter” field stored in the CAP is acquired. In step S717, the control unit 301 compares the number of power transmitters measured in step S715, and the value in the “Number of power transmitter” field stored in the CAP. As a result, when the numbers are the same (YES in step S717), it is determined that all the power transmitters are included in the same power transmission apparatus, and the processing proceeds to step S718. In step S718, normal power receiving processing is executed. In a case where the values are different (NO in step S717), it is determined that there is a power transmitter not included in the same power transmission apparatus, and the processing proceeds to step S719. In step S719, power receiving is restricted.

In the present exemplary embodiment, the description has been given using individual identification information and the number of power transmission apparatuses, but information to be used is only required to be information indicating that a plurality of power transmitters is mounted on one power transmission apparatus 100.

### Second Exemplary Embodiment

FIG. 2B illustrates a configuration of a power transmission apparatus 200 according to the present exemplary embodiment. In the present exemplary embodiment, authentication in F621 of FIG. 6A of which the description has been omitted in the first exemplary embodiment will be described.

First of all, the details of communication for device authentication that is to be performed between a power receiver and a power transmitter will be described with reference to FIG. 6C. The device authentication in the present exemplary embodiment is challenge-response device authentication that uses an electronic certificate, and a power receiver authenticates a power transmitter. The power transmitter can authenticate a power receiver, or both can authenticate the others.

FIG. 6C illustrates the details of authentication processing.

A power receiver operates as an initiator that transmits a challenge text to a power transmitter, and the power transmitter operates as a responder that encrypts the challenge text received from the power receiver, and transmits the encrypted challenge text to the power receiver. First of all, the power receiver serving as an initiator transmits a GET_DIGESTS message to the power transmitter serving as a responder (F622). The GET_DIGESTS message is a message for requesting information regarding an electronic certificate owned by the receiving device (power transmitter).

The power transmitter transmits DIGESTS to the power receiver in response to the GET_DIGESTS message (F623). The DIGESTS is information regarding an electronic certificate owned by the device (power transmitter) that has transmitted the DIGESTS, and is often obtained by accessing a secure element.

Subsequently, the power receiver transmits a GET_CERTIFICATE message requesting detailed information regarding an electronic certificate, to the power transmitter (F624). The power transmitter transmits CERTIFICATE to the power receiver in response to the GET_CERTIFICATE message from the power receiver (F625). The CERTIFICATE is information regarding an electronic certificate, and is often obtained by accessing a secure element. The power receiver then transmits a CHALLENGE message including a challenge text, to the power transmitter (F626). The power transmitter then transmits CHALLENGE_AUTH obtained by encrypting the challenge text received from the power receiver, to the power receiver by accessing a secure element (F627). In a case where the legitimacy of RESPONSE received from the power transmitter has been confirmed, the power receiver determines that device authentication has succeeded, and when this is not such a case, the power receiver determines that device authentication has failed, and the processing ends.

Hereinafter, a message such as GET_DIGESTS, GET_CERTIFICATE, or CHALLENGE to be transmitted by an initiator to a responder to request information will be represented as an authentication request (Auhentication_Request). In addition, a message such as DIGESTS, CERTIFICATE, or CHALLENGE_AUTH to be transmitted by a responder as a response to an authentication request will be represented as an authentication response (Authentication_Response).

### Power Transmission Apparatus

A configuration example of the power transmission apparatus 200 according to the present exemplary embodiment will now be described with reference to FIG. 2B. The components 201 to 209 have been described in the first exemplary embodiment, and thus the description will be omitted. A secure element 210 is an IC that performs encryption processing, and is to be used in an authentication sequence to be performed by the communication unit 204 of the power transmission apparatus 200 and the communication unit 303 of the power receiving apparatus 101. In the present exemplary embodiment, an example in which the power transmission apparatus 100 includes only one secure element 210 will be described.

### Exemplary Embodiment Flowchart

In a case where the power transmission apparatus 200 including a plurality of power transmitters 207 performs authentication, when a plurality of secure elements 210 is provided, an issue of cost increase arises. A plurality of pieces of encryption processing are also performed, and thereby the processing gets complicated. The present exemplary embodiment is directed to providing a power transmission technique in which the number of required secure elements becomes one even in the power transmission apparatus 100 including a plurality of power transmitters 207.

A flowchart of the power transmission apparatus 200 according to the present exemplary embodiment will now be described with reference to FIG. 7D. A sequence to be performed between each power receiver and each power transmitter is as described with reference to FIG. 6A. The processing will be described to be performed after it is determined in step S702 to be YES in the first exemplary embodiment. First of all, in step S709, it is determined whether pieces of individual identification information of power transmitters corresponding to the respective power receivers 309 are the same. In a case where pieces of individual identification information are the same (YES in step S709), the processing proceeds to step S710. In step S710, first of all, authentication processing with one power transmitter is executed. For example, in the case of the power transmission apparatus 200, in step S710, the above-described authentication sequence is performed between the first power transmitter 207a and the first power receiver 309a. In step S711, the control unit 301 determines whether the authentication has succeeded. In a case where the authentication has succeeded (YES in step S711), thereafter, it is next considered to perform authentication between the second power transmitter 207b and the power receiver 309b, and between the third power transmitter 207c and the power receiver 309c. Nevertheless, because the second power transmitter 207b and the third power transmitter 207c are included in the same power transmission apparatus 200 as the first power transmitter 207a, it is obvious that the authentication succeeds. For this reason, it is possible to shorten a time by omitting the processing. That is, in a case where the authentication has succeeded (YES in step S711), the processing proceeds to step S712. In step S712, it is determined that authentication between the other two power transmitters and the power receivers 309 has also succeeded. Accordingly, in step S713, SRQ (GP) requesting 15 W, for example, is transmitted to each power transmitter 207. FIG. 6D is a sequence diagram illustrating the processing. Authentication is confirmed only between a first power transmitter and a first power receiver. Because it is determined that the power transmitters are included in the same power transmission apparatus 200, it is determined that all authentications have succeeded, only by confirming that only one authentication has succeeded.

In contrast, in a case where pieces of individual identification information of the power transmitters are not the same (NO in step S709), because there is a possibility that the power transmitters are included in different power transmission apparatuses, the processing proceeds to step S714. In step S714, it is determined that authentication with other power transmitters has failed, and GP is restricted to 5 W, for example. Also in a case where authentication has failed (NO in step S711), the processing proceeds to step S714. In step S714, it is determined that authentication with other power transmission apparatuses has failed, and GP is restricted to 5 W.

### Third Exemplary Embodiment

In the second exemplary embodiment, an example has been described in which the power receiving apparatus 300 operates as an initiator of authentication, and the power transmission apparatus 200 operates as a responder. In the present exemplary embodiment, an example will be described in which the power transmission apparatus 100 operates as an initiator, and a power receiving apparatus 300 illustrated in FIG. 3B operates as a responder.

### Power Receiving Apparatus

A configuration example of the power receiving apparatus 300 according to the present exemplary embodiment will now be described with reference to FIG. 3B. The components 301 to 311 have been described in the first exemplary embodiment, and thus the description will be omitted. A secure element 312 is an IC that performs encryption processing, and is used in an authentication sequence to be performed by the communication unit 204 of the power transmission apparatus 100 and the communication unit 303 of the power receiving apparatus 300. In the third exemplary embodiment, an example in which the power receiving apparatus 300 includes only one secure element 312 will be described.

### Exemplary Embodiment Flowchart

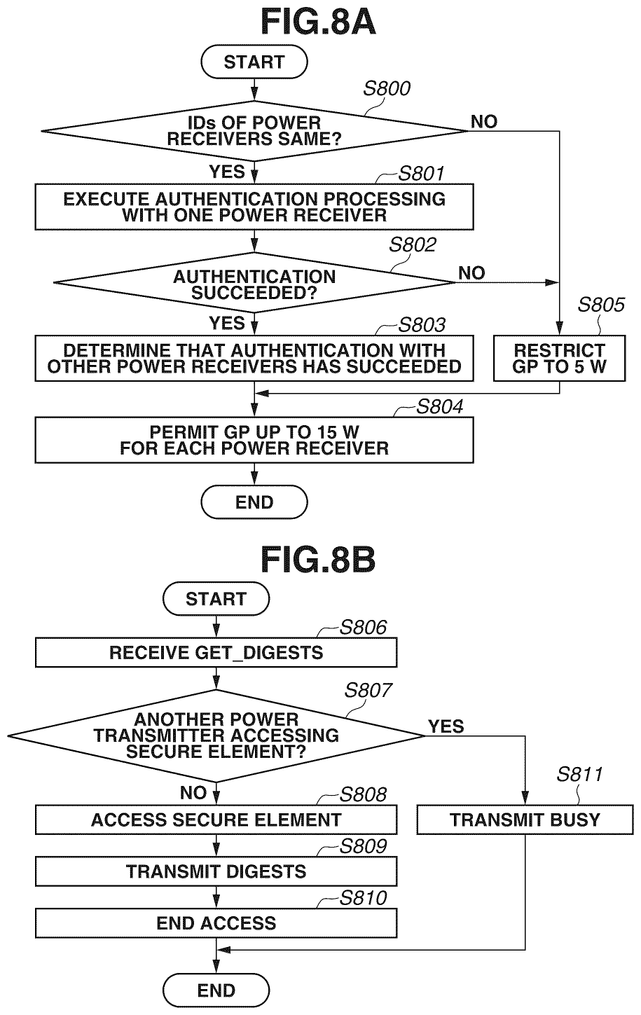

A flowchart of the power transmission apparatus 200 according to the present exemplary embodiment will now be described with reference to FIG. 8A. The sequence of the power transmitter has been described with reference to FIG. 6A, and thus the description thereof will be omitted. The power transmitter collects individual identification information of the power receiver in F604.

In step S800, the control unit 201 of the power transmission apparatus 100 collects collection results of individual identification information of corresponding power receivers from a plurality of power transmitters 207, and checks whether all of these are the same. Here, it is assumed that all of these are the same as illustrated in FIG. 4B. In a case where all pieces of individual identification information are the same (YES in step S800), the processing proceeds to step S801. In step S801, first of all, authentication processing is executed with one power receiver.

For example, in the case of the power receiving apparatus 300, in step S801, the above-described authentication is performed between the first power transmitter 207a and the first power receiver 309a. In step S802, the control unit 201 determines whether the authentication has succeeded. Here, similarly to the second exemplary embodiment, when the authentication has succeeded (YES in step S802), the processing proceeds to step S803. In step S803, it is determined that authentication between the other two power transmitters and the power receivers 309 has also succeeded. Then, Negotiable Load Power is set to 15 W for each power receiver. That is, in step S804, the power transmission apparatus 200 permits GP up to 15 W. FIG. 6D is a sequence diagram illustrating the processing (F630). Authentication is confirmed only between a first power transmitter and a first power receiver. Because it is determined that the power transmitters are included in the same power transmission apparatus 200, it is determined that all authentications have succeeded, only by confirming that only one authentication has succeeded.

In contrast, in a case where collection results of pieces of individual identification information of the power receivers are not the same (NO in step S800), there is a possibility that the power receivers are included in different power receiving apparatuses, the processing proceeds to step S805. In step S805, it is determined that authentication with other power receivers 309 has failed, and GP is restricted to 5 W, for example. Specifically, the control unit 201 of the power transmission apparatus 100 that has received SRQ (GP:15 W) from a power receiver performs control in such a manner as to transmit NAK serving as negative acknowledgement. Also in a case where authentication has failed (NO in step S802), the processing proceeds to step S805. In step S805, it is determined that authentication with other power transmission apparatuses has failed, and GP is restricted to 5 W.

In the present exemplary embodiment, the description has been given using individual identification information, but information to be used is only required to be information indicating that a plurality of power receivers is mounted on one power receiving apparatus 101, like a Wireless Power ID (represented by WPID).

### Fourth Exemplary Embodiment

In the present exemplary embodiment, a system of the power transmission apparatus 200 illustrated in FIG. 2B, and a power receiving apparatus 400 illustrated in FIG. 3C will be described. FIG. 1B is a system diagram. In this manner, the power transmission apparatus 200 can perform wireless power transmission to a plurality of power receiving apparatuses 400 using different power transmitters.

The first power transmitter 207a, the second power transmitter 207b, and the third power transmitter 207c in the present exemplary embodiment can have different capabilities such as maximum power that can be transmitted. Specifically, the maximum power that can be transmitted by the first power transmitter 207a can be 15 W, the maximum power that can be transmitted by the second power transmitter 207b can be 5 W, and the maximum power that can be transmitted by the third power transmitter 207c can be 50 W. In addition, a power transmission frequency of the first power transmitter 207a and the third power transmitter 207c can be 360 kHz (kilohertz), and a power transmission frequency of the second power transmitter 207b can be in a 100-kHz band.

### Power Receiving Apparatus

The power receiving apparatus 400 according to the present exemplary embodiment includes the control unit 301, the charging unit 306, the battery 307, the switch unit 308, the memory 310, and the UI unit 311. That is, the power receiving apparatus 400 includes one power receiver 309. Each component is the same as that in the first exemplary embodiment, and thus the description will be omitted. The power receiving apparatus 400 can also include the secure element 312.

### System Configuration

FIG. 1B is a system diagram illustrating the power receiving apparatus 400 and the power transmission apparatus 200 according to the present exemplary embodiment, and a configuration of a system according to an exemplary embodiment will be described.

FIG. 1B is a diagram illustrating a configuration example of a wireless power transmission system. The description of a part similar to the part in FIG. 1A that has been described in the first exemplary embodiment will be omitted, and as described above, the power receiving apparatus 101 according to the present exemplary embodiment includes a single power receiver 309. Because the power transmission apparatus 100 includes three power transmitters, the number of power receiving apparatuses to which the power transmission apparatus 100 can transmit power is three at most.

### Exemplary Embodiment Flowchart

In a case where the number of secure elements that can access a plurality of power transmitters 207 as illustrated in FIG. 2B is one, the other power transmitters 207 cannot make access when a certain power transmitter 207 is accessing. Because it is not possible to transmit a response related to authentication, with respect to different power receiving apparatuses 400, there is an issue that time-out occurs and authentication might fail. In contrast to this, the present exemplary embodiment is directed to providing a power transmission technique that can avoid a failure in authentication even in the power transmission apparatus 200 including a plurality of power transmitters 207.

A flowchart of the power transmission apparatus 200 according to the present exemplary embodiment will now be described with reference to FIG. 8B. First of all, in step S806, the power transmission apparatus 200 receives GET_DIGESTS from a first power receiving apparatus 400a via the first power transmitter 207a. In step S807, the power transmission apparatus 200 that has received GET_DIGESTS checks a current access status in the memory 208 of the control unit 201 to determine whether the power transmitter 207 accessing the secure element 210 of itself exists. Here, a power transmitter accessing the secure element 210 stores information indicating that the power transmitter has started access, into the memory 208 before an access start. The power transmitter also stores information indicating that the power transmitter has ended access, into the memory 208 before an access end.

When the control unit 201 that has confirmed the access status determines that no power transmitter 207 has made an access (NO in step S807), the processing proceeds to step S808. In step S808, the control unit 201 stores information indicating that access has started, into the memory 208, and accesses the secure element. Thereafter, in step S809, the first power transmitter 207a that has received DIGESTS from the secure element transmits DIGESTS to the first power receiving apparatus 400a. The control unit 201 stores information indicating that access has ended, into the memory 208.

In contrast, in a case where another power transmitter is making access (YES in step S807), the processing proceeds to step S811. In step S811, the control unit 201 notifies the power receiving apparatus 400 of an ERROR message indicating BUSY. For example, this case is a case of performing authentication of a second power receiving apparatus 400b and the second power transmitter 207b during authentication of the first power receiving apparatus 400a and the first power transmitter 207a. The description has been given using GET_DIGESTS as an example, but similar processing is performed using a message from the power receiving apparatus 400 to the power transmission apparatus 200 such as GET_CERTIFICATE or CHALLENGE accessing a secure element.

The BUSY is an ERROR CODE indicating that “the device is currently unable to make a response, but can make a response later”, and is normally used in a case where a certain device cannot end processing within a predetermined time. That is, in a case where the power transmission apparatus 200 receives an authentication request such as GET_DIGESTS, but a timing requirement defining a response to the authentication request cannot be satisfied, an error response of BUSY is made within a time requested by the timing requirement. The power receiving apparatus 400 that has received BUSY transmits a request to which an ERROR has returned again after a predetermined period of time, to the power transmitter. The timing requirement can be defined in the WPC standard, or can be determined by negotiation between the power transmission apparatus 200 (or power transmitter 207) and the power receiving apparatus 400 (or power receiver).

FIG. 6E is a sequence diagram illustrating a flowchart of the power transmission apparatus 200 according to the present exemplary embodiment that has been described above. The power transmission apparatus 200, having received GET_DIGESTS from two power receiving apparatuses 400, delivers a message received earlier (F622), to a secure element, and performs processing (F628). When the processing of the secure element (F628) ends, the power transmission apparatus 200 transmits DIGESTS to the first power receiving apparatus 400a (F623). Regarding a message received while accessing the secure element (F622), the power transmission apparatus 200 performs processing of returning BUSY to the second power receiving apparatus 400b serving as a transmission destination of the message (F631). When a predetermined period of time elapses after the reception of BUSY, the second power receiving apparatus 400b can perform retransmission of a request (F622a). Alternatively, the power receiving apparatus 400 can avoid performing retransmission. Hereinafter, processing to be performed by the power transmission apparatus 200 such that the power receiving apparatus 400 does not perform retransmission of a message illustrated in F622a will be described.

In F631, the power transmission apparatus 200 transmits an ERROR message as an ERROR CODE=BUSY. Here, the power receiving apparatus 400 is notified that “request is not to be retransmitted” by setting ERROR DATA in the message to a value different from a normal value.

The power receiving apparatus 400 that has received the message analyzes the message, and avoids performing retransmission of a request to the power transmission apparatus 200. The power transmission apparatus 200, having transmitted DIGESTS to the first power receiving apparatus 400a (F623), accesses a secure element to prepare DIGESTS to be transmitted to the second power receiving apparatus 400b next, and performs calculation for making a response to GET_DIGESTS (F628a). When the preparation is completed, the power transmission apparatus 200 transmits DIGESTS to the second power receiving apparatus 400b (F623a).

Here, the control unit 201 of the power transmission apparatus 200 is assumed to determine that there is the power receiving apparatus 400 waiting for DIGESTS, by storing and checking such information in the memory 208. By performing control in such a manner, an effect is obtained of being able to reduce messages to be transmitted between the power transmission apparatus 200 and the power receiving apparatus 400, and to transmit and receive an intended message earlier.

### Modified Example of Fourth Exemplary Embodiment

Here, there is a plurality of situations where the power transmitter 207 can transmit an ERROR message. One situation is a situation where another power transmitter 207 performs authentication processing including transmission and reception of an authentication request and an authentication response, with another power receiving apparatus 400. This situation has been exemplified with reference to FIG. 6E. Aside from this example, a plurality of pieces of processing are executed from when GET_DIGESTS (F622) is received, to when CHALLENGE_AUTH (F627) is transmitted as illustrated in FIG. 6C.

As a situation other than this, for example, there is a situation where an authentication response cannot be transmitted with a prescribed timing requirement due to processing capability of a control unit of the power transmitter 207. For example, a processing speed of authentication processing sometimes gets slow by the control unit of the power transmitter 207 performing processing other than authentication processing. Even in this case, the power transmitter 207 transmits an ERROR message in which ERROR DATA indicates “BUSY”, to the power receiving apparatus 400.

Because the power receiving apparatus 400 receives in any situation an ERROR message in which ERROR DATA indicates “BUSY”, there is an issue that the power transmitter 207 cannot determine which state. In view of the foregoing, the power transmitter 207 of the present exemplary embodiment can make a distinction between these situations based on ERROR DATA to be transmitted. Furthermore, processing to be performed by the power receiving apparatus 400 can also be designated by ERROR DATA.

Specifically, the power transmitter 207 can store the following as ERROR DATA related to an ERROR CODE indicating BUSY, among ERROR messages serving as authentication responses. That is, “0x00” (authentication response 1), “0x01” (authentication response 2), “0x02” (authentication response 3), and “0x03 (authentication response 4)” can be stored. Each authentication response will be described below.

### Authentication Response 1

The authentication response 1 indicates a situation where another power transmitter 207 is not executing authentication processing with another power receiving apparatus 400, but cannot transmit an authentication response with a prescribed timing requirement due to processing capability. The authentication response 1 can be used in a case where, when any power transmitter 207 of the power transmission apparatus 200 is executing authentication processing with the power receiving apparatus 400, a different power transmitter 207 cannot perform authentication processing with another power receiving apparatus 400.

### Authentication Response 2

The authentication response 2 indicates that, because another power transmitter 207 is executing authentication processing with another power receiving apparatus 400, it is unable to transmit an authentication response with a prescribed timing requirement. The authentication response 2 can be used in a case where, when any power transmitter 207 of the power transmission apparatus 200 is executing authentication processing with the power receiving apparatus 400, a different power transmitter 207 cannot perform authentication processing with another power receiving apparatus 400. In addition, the power receiving apparatus 400 that has received the authentication response 2 needs to perform retransmission of an authentication request after a lapse of a predetermined period of time.

### Authentication Response 3

The authentication response 3 indicates that, because another power transmitter 207 is executing authentication processing with another power receiving apparatus 400, it is unable to transmit an authentication response with a prescribed timing requirement, and further indicates that a signal to the power receiving apparatus 400 from the power transmitter 207 is waited for. Similarly to the authentication response 2, the authentication response 3 can be used in a case where, when any power transmitter 207 of the power transmission apparatus 200 is executing authentication processing with the power receiving apparatus 400, a different power transmitter 207 cannot perform authentication processing with another power receiving apparatus 400. Unlike the authentication response 2, the power receiving apparatus 400 that has received the authentication response 3 does not perform retransmission of an authentication request until a specific signal is transmitted from the power transmitter 207. When the power receiving apparatus 400 receives a specific signal from the power transmitter 207, the power receiving apparatus 400 performs retransmission of an authentication request.

### Authentication Response 4

The authentication response 4 indicates a situation where, because another power transmitter 207 is accessing a secure element, it is unable to transmit an authentication response with a prescribed timing requirement. The authentication response 4 can be used in a case where, even when any power transmitter 207 of the power transmission apparatus 200 is executing authentication processing with the power receiving apparatus 400, a different power transmitter 207 can perform authentication processing with another power receiving apparatus 400. A device including a memory, such as a secure element, is often prohibited to permit simultaneous access such as reading or writing to and from the memory from a plurality of other devices. Thus, in a case where, while one power transmitter 207 is accessing the secure element, a different power transmitter 207 tries to access the secure element, the authentication response 4 is transmitted. In other words, data in which an ERROR CODE indicates BUSY and ERROR DATA is “0x04” is transmitted to another power receiving apparatus 400.

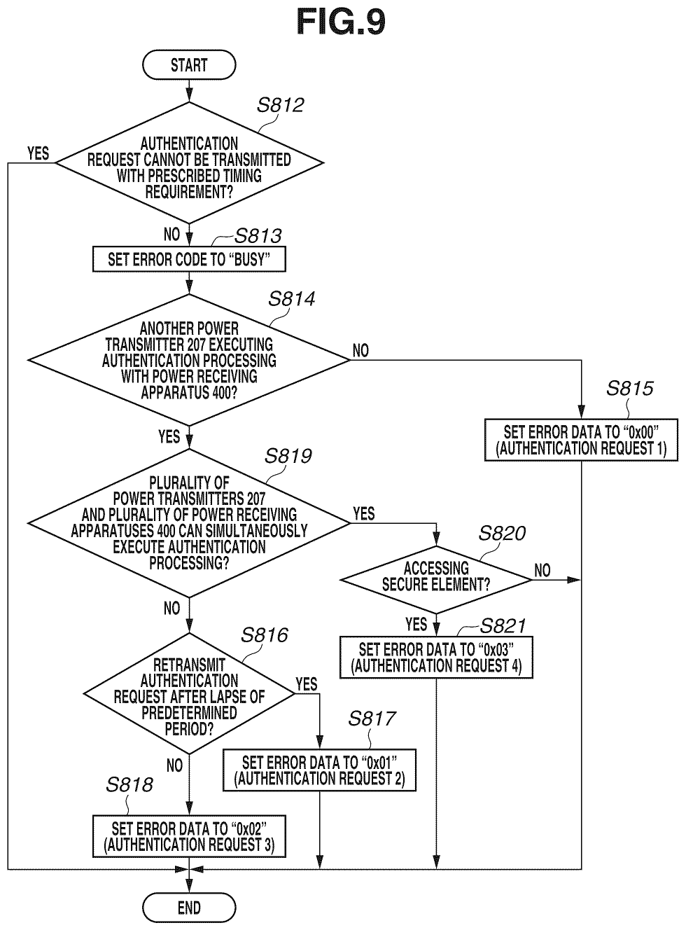

FIG. 9 is a flowchart illustrating an operation to be performed when the power transmission apparatus 200 (power transmitter 207) transmits the authentication responses 1 to 4. When the power transmitter 207 receives an authentication request, it is determined, in step S812, whether an authentication response cannot be transmitted with a prescribed timing requirement. In a case where an authentication response cannot be transmitted (NO in step S812), the processing proceeds to step S813. In step S813, an ERROR_CODE is set to “BUSY”.

In step S814, it is determined whether a different power transmitter 207 is executing authentication processing with the power receiving apparatus 400. In a case where a different power transmitter 207 is not executing authentication processing (NO in step S814), the processing proceeds to step S815. In step S815, ERROR_DATA is set to “0x00” (authentication response 1).

In a case where a different power transmitter 207 is executing authentication processing (YES in step S814), the processing proceeds to step S819. In step S819, the power transmission apparatus 200 (or power transmitter 207) determines whether the power transmission apparatus 200 has a specification in which a plurality of power transmitters 207 and a plurality of power receiving apparatuses 400 can simultaneously execute authentication processing. In a case where the power transmission apparatus 200 has a specification in which a plurality of power transmitters 207 and a plurality of power receiving apparatuses 400 can simultaneously execute authentication processing (YES in step S819), the processing proceeds to step S820. In step S820, it is determined whether another power transmitter 207 is already accessing a secure element. If another power transmitter 207 is already accessing a secure element (YES in step S820), the processing proceeds to step S821. In step S821, the power transmitter 207 sets ERROR DATA to “0x03” (authentication response 4). In contrast, in a case where another power transmitter 207 is not accessing a secure element (NO in step S820), the processing ends, access is made to a normal secure element, and an authentication response is made. The authentication response to be made in this case is DIGESTS to be transmitted in response to a GET_DIGESTS message, for example.

In a case where the power transmission apparatus 200 does not have a specification in which a plurality of power transmitters 207 and a plurality of power receiving apparatuses 400 can simultaneously execute authentication processing (NO in step S819), the processing proceeds to step S816. In step S816, it is determined whether to retransmit an authentication request to the power receiving apparatus 400 after the lapse of a preset predetermined time. Here, in the case of retransmitting an authentication request to the power receiving apparatus 400 after the lapse of a predetermined time (YES in step S816), the processing proceeds to step S817. In step S817, ERROR_DATA is set to “0x01” (authentication response 2). In the case of not retransmitting an authentication request to the power receiving apparatus 400 after the lapse of a predetermined time (NO in step S816), the processing proceeds to step S818. In step S818, ERROR_DATA is set to “0x02” (authentication response 3).

In a case where an authentication response can be transmitted (YES in step S812), the processing ends, access is made to a normal secure element, and an authentication response is made. The authentication response to be made in this case is DIGESTS to be transmitted in response to a GET_DIGESTS message, for example.

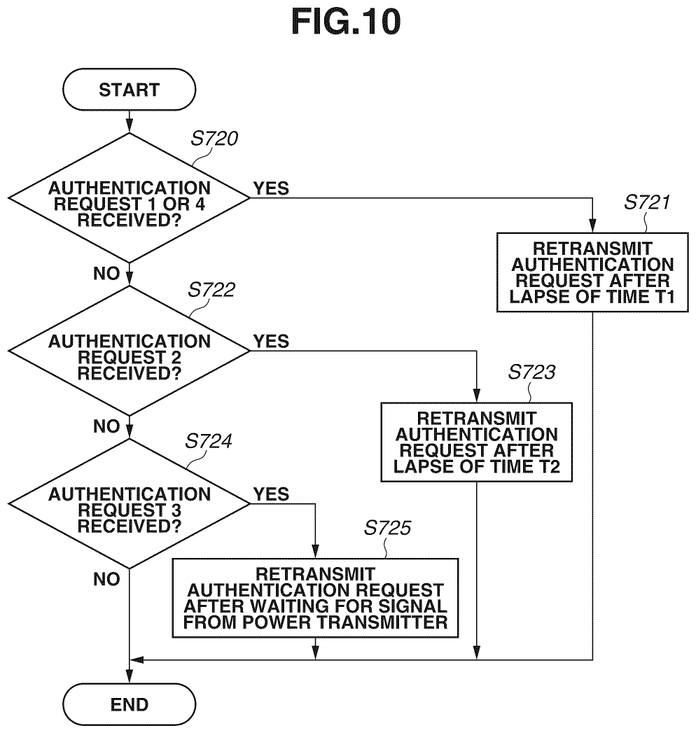

An operation to be performed in a case where the power receiving apparatus 400 receives an authentication response indicating BUSY will be described below with reference to FIG. 10. In the case of a response (e.g., DIGESTS) other than an authentication response indicating BUSY, normal processing is executed, and thus the processing is omitted here.

First of all, in step S720, the power receiving apparatus 400 determines whether the authentication response 1 or 4 has been received.

In a case where the authentication response 1 or 4 has been received (YES in step S720), the processing proceeds to step S721. In step S721, the power receiving apparatus 400 retransmits an authentication request (retries an authentication request) after the lapse of a time T1. In contrast, in a case where the authentication response 1 or 4 has not been received (NO in step S720), the processing proceeds to step S722. In step S722, the power receiving apparatus 400 determines whether the authentication response 2 has been received. In a case where the authentication response 2 has been received (YES in step S722), the processing proceeds to step S723. In step S723, the power receiving apparatus 400 retransmits an authentication request (retries an authentication request) after the lapse of a time T2. In a case where the authentication response 2 has not been received (NO in step S722), the processing proceeds to step S724. In step S724, the power receiving apparatus 400 determines whether the authentication response 3 has been received.

In a case where the authentication response 3 has been received (YES in step S724), the processing proceeds to step S725. In step S725, the power receiving apparatus 400 waits for a signal from the power transmitter 207. The power receiving apparatus 400 then retransmits an authentication request (retries an authentication request) being triggered by the signal. In a case where the authentication response 3 has not been received (NO in step S724), there is a possibility that an authentication response other than the authentication responses 1 to 4 has been received, but the power receiving apparatus 400 does nothing in this case.

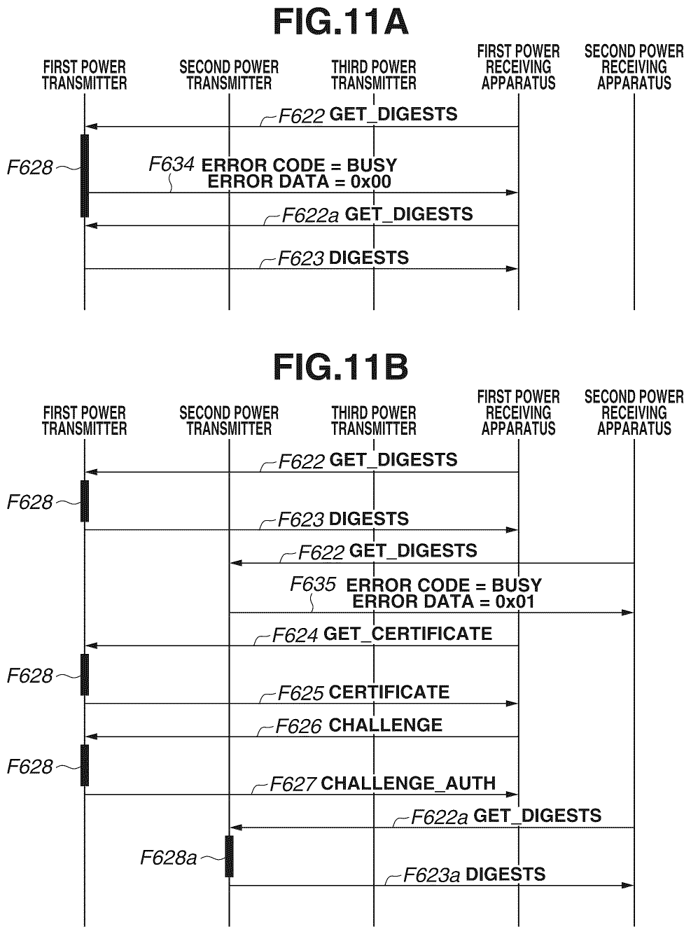

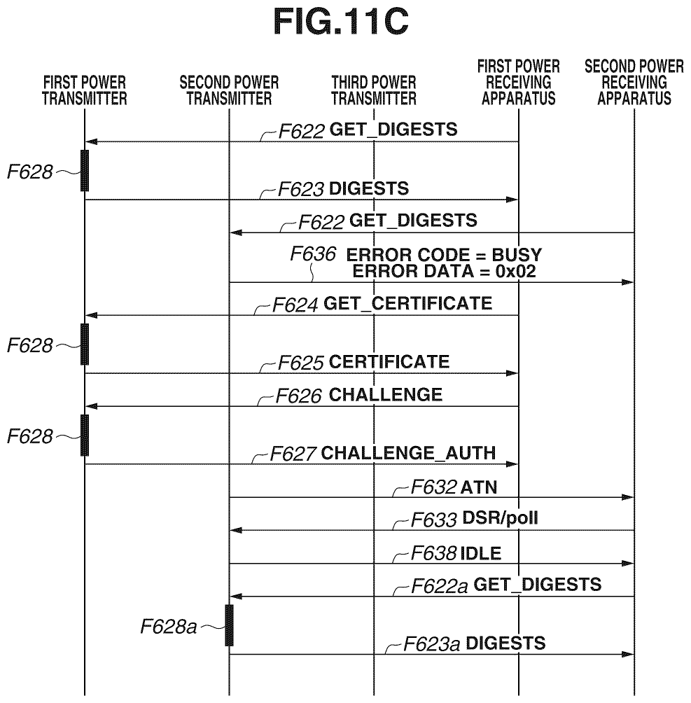

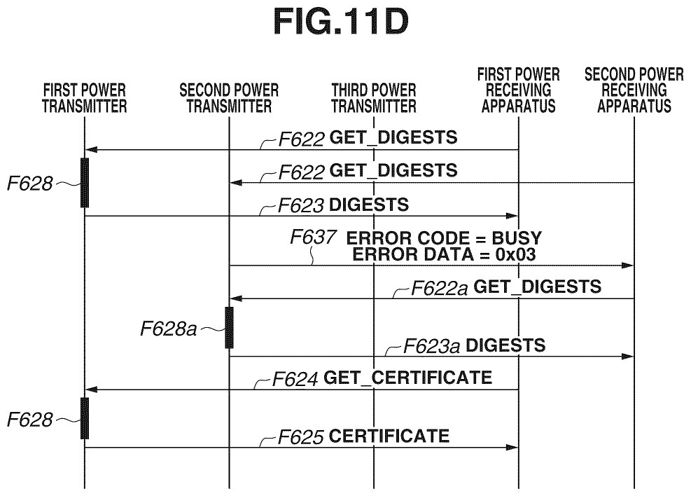

Here, the time T2 is assumed to be longer than the time T1. The reason why the time T2 is made longer than the time T1 will be described with reference to FIG. 11A. A case where the power transmitter 207 transmits the authentication response 1 includes, for example, the following case. The case is a case where the power transmitter 207 receives an authentication request (e.g., GET_DIGESTS), and prepares information regarding DIGESTS as an authentication response, but cannot transmit an authentication response within a requested time from when the authentication request is received, because the processing of a control unit is slow. In this case, the power transmitter 207 transmits, to the power receiving apparatus 400, a message (authentication response 1) in which an ERROR CODE indicates “BUSY” and ERROR DATA is “0x00”, as an authentication response to GET_DIGESTS (F634). The power transmitter 207 then continuously executes the processing of the secure element (F628).

When the power receiving apparatus 400 receives the authentication response 1, after a waiting for the time T1, transmits GET_DIGESTS again as an authentication request (F622a). In a case where the power transmitter 207 receives GET_DIGESTS again, the power transmitter 207 transmits DIGESTS to the power receiving apparatus 400 as an authentication response when DIGESTS can be transmitted (F623). In this manner, the time T1 is a wait time for the control unit calculating and transmitting an authentication response to a certain authentication request (e.g., DIGESTS in response to GET_DIGESTS).

In contrast, an operation to be performed when the power transmitter 207 transmits the authentication response 2 will now be described with reference to FIG. 11B. Here, processing will be described, as an example, to be performed by the second power transmitter 207b in a case where the first power transmitter 207a is executing a series of authentication processing with the first power receiving apparatus 400a. In this case, in a case where the second power transmitter 207b receives an authentication request from the second power receiving apparatus 400b (F622), the second power transmitter 207b cannot start authentication processing. For this reason, the second power transmitter 207b transmits a message in which an ERROR CODE indicates “BUSY” and ERROR DATA is “0x01”, to the second power receiving apparatus 400b (F635). For the second power transmitter 207b starting authentication processing with the second power receiving apparatus 400b, it is necessary to end a series of authentication processing already started by the first power transmitter 207a. The time T2 is a time until a series of authentication processing already started by the first power transmitter 207a ends. For this reason, the time (time T2) until a series of authentication processing already started by the first power transmitter 207a ends becomes longer than the time (time T1) until a single piece of authentication processing ends. It is therefore desirable that the time T2 is set to a time longer than the time T1. After the time T2 elapses, the second power receiving apparatus 400b retransmits an authentication request (F622a).

In a case where the time T1 and the time T2 are equal, the power receiving apparatus 400 that has received the authentication response 2 transmits an authentication request again after the lapse of the time T1, but until the series of authentication processing ends, there is wasted effort of repeatedly receiving the authentication response 2 and transmitting an authentication request. By setting the time T2 to a time longer than the time T1 in this manner makes it possible to avoid unnecessary message transmission and receiving. Alternatively, when the time T1 and the time T2 are set based on a time from when a single piece of authentication processing is started to when the authentication processing ends, an unnecessarily long standby time is generated, and authentication processing of a different power transmitter 207 might be started during the time, and user convenience of the power receiving apparatus 400 might deteriorate.

FIG. 11C illustrates a sequence in a situation of making the authentication response 3. Because the first power transmitter 207a is executing a series of authentication processing with the first power receiving apparatus 400a, the second power transmitter 207b cannot start authentication processing with the second power receiving apparatus 400b. In this case, the second power transmitter 207b transmits a message (authentication response 3) in which an ERROR CODE indicates “BUSY” and ERROR DATA is “0x02”, to the power receiving apparatus 400 (F636).

The second power receiving apparatus 400b that has received the authentication response 3 waist for a signal from the second power transmitter 207b. In a case where authentication processing of the first power transmitter 207a ends (F627), the second power transmitter 207b transmits an Attention (ATN) message to the second power receiving apparatus 400b (F632). The ATN is a packet to be transmitted to request the power receiving apparatus 400 to pay attention, in a case where the power transmitter 207 has a packet to be transmitted to the power receiving apparatus 400. When the second power receiving apparatus 400b receives the ATN, the second power receiving apparatus 400b transmits a Data Stream Response (DSR)/Poll (F633). The DSR/Poll is a packet to be transmitted in a case where the power receiving apparatus 400 requests the power transmitter 207 to transmit a data packet.

When the second power transmitter 207b receives the DSR/Poll, the second power transmitter 207b transmits an IDLE message serving as a message for notifying the second power receiving apparatus 400b that a BUSY state has been cleared (F638). When the second power receiving apparatus 400b receives the IDLE message from the second power transmitter 207b, the second power receiving apparatus 400b retransmits an authentication request (F622a). With this configuration, the power receiving apparatus 400 can retransmit an authentication request at a timing at which the power transmitter 207 can perform authentication processing. Thus, it is possible to avoid repeating retransmission a number of times.

FIG. 11D illustrates a sequence in a situation of making the authentication response 4. In this case, even when the first power transmitter 207a is executing a series of authentication processing with the first power receiving apparatus 400a, the second power transmitter 207b can start authentication processing with the second power receiving apparatus 400b. Nevertheless, a plurality of power transmitters 207 cannot simultaneously access a secure element.

When the first power transmitter 207a receives GET_DIGESTS from the first power receiving apparatus 400a (F622), and accesses the secure element (F628), the second power transmitter 207b receives GET_DIGESTS from the second power receiving apparatus 400b (F622). Because the first power transmitter 207a is accessing the secure element, the second power transmitter 207b cannot access the secure element. Accordingly, the second power transmitter 207b transmits a message (authentication response 4) in which an ERROR CODE indicates “BUSY” and ERROR DATA is “0x03”, to the second power receiving apparatus 400b (F637).

The power receiving apparatus 400 that has received the authentication response 4 retransmits GET_DIGESTS after the lapse of the time T1 (F622a). Because the first power transmitter 207a is not accessing the secure element at a timing at which GET_DIGESTS is retransmitted, the second power transmitter 207b accesses the secure element (F628a), and transmits DIGESTS to the second power receiving apparatus 400b (F623a).

When the first power transmitter 207a receives GET_CERTIFICATES from the first power receiving apparatus 400a (F624), the first power transmitter 207a accesses the secure element (F628), and transmits CERTIFICATES to the first power receiving apparatus 400a (F625). In this manner, it becomes possible for a plurality of power transmitters 207 and a plurality of power receiving apparatuses 400 to concurrently execute authentication processing. Here, a wait time required in a case where ERROR_DATA is “0x03” can be the same as the wait time T1 required in the case of the authentication response 1 (refer to FIG. 10). A wait time required in the case of the authentication response 4 can also be shorter than the wait time T1 of the authentication response 1. In this case, it is possible to perform authentication processing earlier as compared with the time T1 required in the case of the authentication response 1. The wait time required in the case of the authentication response 4 can also be made longer than the wait time T1 of the authentication response 1 and shorter than the wait time T2 of the authentication response 2. In this case, it is possible to reduce retransmission of an authentication request.

The time T1 and the time T2 can be independently set by the power receiving apparatus 400, or can be determined by the power transmission apparatus 200 (or the power transmitter 207) and the power receiving apparatus 400 through negotiation.

Referring to FIG. 9, the description has been given assuming that, in a case where another power transmitter 207 is accessing a secure element (YES in step S820), ERROR DATA is set to “0x03”. Nevertheless, determination (determination similar to step S816) as to whether to further retransmit an authentication request in a case where another power transmitter 207 is accessing a secure element (YES in step S820) can also be added. Specifically, in a case where it is determined in the determination to retransmit an authentication request, ERROR DATA can be set to “0x03” (authentication response 4), and when this is not the case, ERROR DATA can be set to “0x04” (authentication response 5). The authentication response 5 indicates a situation where, because another power transmitter 207 is accessing a secure element, an authentication response cannot be transmitted with a prescribed timing requirement. The authentication response 5 also indicates waiting for a specific signal to be transmitted from the power transmitter 207, similarly to the authentication response 3. The power receiving apparatus 400 that has received the authentication response 5 waits for a specific signal to be transmitted from the power transmitter 207, and in a case where the specific signal is received, the power receiving apparatus 400 retransmits an authentication request.

In the present exemplary embodiment, the description has been given assuming that the power receiving apparatus 400 is an initiator and the power transmitter 207 is a responder. Alternatively, the power receiving apparatus 400 can also be a responder and the power transmitter 207 can also be an initiator.

### Other Exemplary Embodiments

In the exemplary embodiment of the present disclosure, at least part of the processing illustrated in the flowcharts in FIGS. 7A to 7D, 8A, and 8B can also be implemented by hardware. For example, it is possible to automatically generate a dedicated circuit on an FPGA from a program for implementing each step by using a predetermined compiler. Similarly to an FPGA, a gate array circuit can also be formed and implemented as hardware.

A power transmission apparatus and a power receiving apparatus can also be image input apparatuses such as an imaging apparatus (e.g., camera, video camera) or a scanner, for example, or image output apparatuses such as a printer, a copier, or a projector. Storage apparatuses such as a hard disc device or a memory device, or information processing apparatuses such as a personal computer (PC) or a smartphone can also be used.

The power receiving apparatus of the present disclosure can be an information terminal device. For example, the information terminal device includes a display unit (display) for displaying information to users, to which power received from a power receiving antenna is supplied. The power received from the power receiving antenna is accumulated in an accumulation unit (battery), and power is supplied from the battery to the display unit. In this case, the power receiving apparatus can include a communication unit for communicating with another apparatus different from the power transmission apparatus. The communication unit can support a communication standard such as near field communication (NFC) or the 5th generation mobile communication system (5G).

The power receiving apparatus according to the present disclosure can also be a vehicle such as an automobile. For example, an automobile serving as the power receiving apparatus can receive power from a charger (power transmission apparatus) via a power transmission antenna installed in a parking space. An automobile serving as the power receiving apparatus can receive power from a charger (power transmission apparatus) via a power transmission antenna buried in a road. In such an automobile, received power can be supplied to a battery. The power in the battery can be supplied to an actuator unit (motor, electrical part) for driving wheels, or can also be used to drive a sensor to be used for driving assistance, or a communication unit that performs communication with an external apparatus. That is, in this case, the power receiving apparatus can include a motor and a sensor to be driven using the battery or received power, and can also include a communication unit that performs communication with an apparatus other than the power transmission apparatus, aside from wheels. The power receiving apparatus can also include an accommodation unit to accommodate persons. For example, the sensor includes a sensor to be used to measure an inter-vehicular distance or a distance to another obstacle. The communication unit can also support the Global Positioning System or Global Positioning Satellite (GPS), for example. The communication unit can also comply with a communication standard such as the 5th generation mobile communication system (5G). The vehicle can also be a bicycle or a motorbike.

The power receiving apparatus of the present disclosure can also be an electrical tool or a home electric appliance. These devices, which serves as the power receiving apparatus, can also include a motor to be driven by received power accumulated in a battery, aside from the battery. These devices can also include a notification unit that notifies a user of a remaining amount of the battery. These devices can also include a communication unit that performs communication with a different apparatus other than the power transmission apparatus. The communication unit can support a communication standard such as NFC or the 5th generation mobile communication system (5G).

The power transmission apparatus of the present disclosure can also be an in-vehicle charger that performs power transmission to a portable information terminal device such as a smartphone or a tablet that supports wireless power transmission, within a vehicle of an automobile. Such an in-vehicle charger can be provided anywhere in the automobile. For example, the in-vehicle charger can be installed in a console of the automobile, or may be installed on an instrument panel (dashboard), at a position between seats of occupants, on a ceiling, or on a door. Nevertheless, it is desirable to avoid installing the in-vehicle charger at a location where the in-vehicle charger disturbs driving. An example in which the power transmission apparatus is an in-vehicle charger has been described, but such a charger is not limited to a charger arranged in a vehicle, and can be installed in transport machinery such as an electric train, an airplane, or a ship. Even in this case, the charger can also be installed at a position between seats of occupants, on a ceiling, or on a door.

A vehicle such as an automobile that includes an in-vehicle charger can also serve as a power transmission apparatus. In this case, the power transmission apparatus includes wheels and a battery, and supplies power to a power receiving apparatus with a power transmission circuit unit or a power transmission antenna using the battery power.

The present invention is not limited to the above-described exemplary embodiment, and various changes and modifications can be made without departing from the spirit and the scope of the present invention. The following claims are therefore appended to set forth the scope of the present invention.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

1. A power transmission apparatus comprising:
a first transmission unit configured to wirelessly transmit power to a power receiving apparatus; and
a second transmission unit configured to wirelessly transmit power to a power receiving apparatus,
wherein, in a case where the second transmission unit receives a request for transmission of information regarding an electronic certificate from a power receiving apparatus before the first transmission unit receives a request for transmission of information regarding an electronic certificate from a power receiving apparatus and the first transmission unit transmits the information regarding the electronic certificate, the second transmission unit transmits a signal different from the information regarding the electronic certificate.

2. The power transmission apparatus according to claim 1, wherein the signal is a signal indicating that a response cannot be currently made but the response can be made later.

3. The power transmission apparatus according to claim 1,
wherein the request for the information regarding the electronic certificate is any of GET_DIGESTS, GET_CERTIFICATE, and CHALLENGE, and
wherein the information regarding the electronic certificate is any of DIGESTS, CERTIFICATE, and CHALLENGE_AUTH.

4. The power transmission apparatus according to claim 1, wherein the signal is an ERROR for issuing a BUSY.

5. A method performed by a power transmission apparatus that includes a first transmission unit configured to wirelessly transmit power to a power receiving apparatus, and a second transmission unit configured to wirelessly transmit power to a power receiving apparatus, the method comprising:
transmitting, in a case where the second transmission unit receives a request for transmission of information regarding an electronic certificate from a power receiving apparatus before the first transmission unit receives a request for transmission of information regarding an electronic certificate from a power receiving apparatus and the first transmission unit transmits the information regarding the electronic certificate, a signal different from the information regarding the electronic certificate with the second transmission unit.

6. A storage medium storing a program for causing a computer to execute the method according to claim 5.
